(19) United States
(12) Patent Application Publication
(10) Pub. No.: US 2025/0328034 A1
(43) Pub. Date: Oct. 23, 2025

(54) ON-CHIP ELECTRO-ABSORPTION MODULATOR

(71) Applicant: Open Light Photonics, Inc., Goleta, CA (US)

(72) Inventors: Krzysztof Szczerba, Sunnyvale, CA (US); John Sonkaly, Laguna Niguel, CA (US); Robert Silvio Guzzon, Santa Barbara, CA (US)

(21) Appl. No.: 18/643,831

(22) Filed: Apr. 23, 2024

(51) Int. Cl. G02F 1/015; G02F 1/025

(52) U.S. Cl. CPC G02F 1/0157; G02F 1/025

(57) ABSTRACT

A photonic integrated circuit (PIC) includes an integrated on-chip electro-absorption modulator (EAM) having a first electrode and a second electrode, the first electrode and second electrode including an anode and a cathode. The PIC includes at least a first biasing network electrically coupled to the first electrode for providing termination and biasing to the EAM. The first biasing network includes at least a first inductor formed on the PIC.

### TECHNICAL FIELD

The present disclosure generally relates to optical devices and more particularly to electro-absorption modulators integrated into photonic integrated circuits.

### BACKGROUND

High density, high-speed electro-absorption modulators (EAMs) are emerging as a key technology for providing high-data rate, low power connectivity for data centers, high performance computers, and machine learning and artificial intelligence applications. Improving the speed of EAMs can potentially improve the performance of applications relying on EAMs.

### BRIEF DESCRIPTION OF THE SEVERAL VIEWS OF THE DRAWINGS

The following description includes discussion of figures having illustrations given by way of example of implementations of embodiments of the disclosure. The drawings should be understood by way of example, and not by way of limitation. As used herein, references to one or more “examples” or “embodiments” are to be understood as describing a particular feature, structure, or characteristic included in at least one implementation of the inventive subject matter, in at least some circumstances. Thus, phrases such as “in one example”, “in some examples”, “in some embodiments”, “in one embodiment” or “in an alternate embodiment” appearing herein describe various embodiments and implementations of the inventive subject matter, and do not necessarily all refer to the same embodiment. However, they are also not necessarily mutually exclusive. To easily identify the discussion of any particular element or act, the most significant digit or digits in a reference number may refer to the figure (“FIG.”) number in which that element or act is first introduced.

FIG. 1 illustrates a plan view of an example on-chip electro-absorption modulator (EAM) having two biasing networks, in accordance with at least one example.

FIG. 2 illustrates a circuit diagram equivalent of the EAM of FIG. 1, in accordance with at least one example.

FIG. 3 illustrates examples of alternative termination inductor shapes for an on-chip EAM, in accordance with at least one example.

FIG. 4A illustrates a circuit diagram of a device including a PIC with an on-chip EAM and several external components, in accordance with at least one example.

FIG. 4B illustrates a circuit diagram of the device of FIG. 4A with an off-PIC ground, in accordance with at least one example.

FIG. 5 illustrates a circuit diagram of a device including an on-chip EAM modeled as a sub-circuit, in accordance with at least one example.

FIG. 6 illustrates a simplified circuit diagram of the device of FIG. 5 in which both biasing networks are modeled jointly as a combined termination resistor and a combined termination inductor, in accordance with at least one example.

FIG. 7 illustrates a graph of the frequency response of an on-chip EAM with varying termination inductance, in accordance with at least one example.

FIG. 8 illustrates time-domain eye diagrams of an EAM with and without termination inductance, in accordance with at least one example.

FIG. 9 illustrates a flowchart showing operations of a method for manufacturing a photonic integrated circuit (PIC) having an EAM with on-chip termination inductance, in accordance with at least one example.

FIG. 10 illustrates a flowchart showing operations of a method for biasing and terminating an electro-absorption modulator (EAM) formed on a photonic integrated circuit (PIC), in accordance with at least one example.

Descriptions of certain details and implementations follow, including a description of the figures, which may depict some or all of the embodiments described below, as well as discussing other potential embodiments or implementations of the inventive concepts presented herein. An overview of embodiments of the disclosure is provided below, followed by a more detailed description with reference to the drawings.

### DETAILED DESCRIPTION

In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, structures, and techniques are not necessarily shown in detail.

The modulation bandwidth of an EAM can be considered a measure of its speed. Improving the modulation bandwidth of an EAM can help to improve its data rate, reduce its system complexity, and reduce its power consumption per transmitted bit.

An EAM using a differential drive signal may exhibit reduced cross-talk and enable the use of a low-nonlinearity differential driver. In a differential driver, the nonlinearities in the positive and negative sides of the output stage cancel out, if operated into a differential load. Differentially driven amplifiers also provide an increased drive swing, which can be used to increase the extinction ratio and the optical modulation amplitude of the EAM.

Inductive peaking is a method to improve the modulation bandwidth of an EAM. Inductive peaking uses an inductor in series with a resistor to reduce the rise time of the voltage across the resistor when operating in parallel with a capacitor. The decreased rise time due to inductive peaking can result in faster voltage level transitions and thus faster logic level transitions, thereby improving the data rate and modulation bandwidth of an EAM or other modulator.

Examples described herein may provide an EAM formed on-chip on a photonic integrated circuit (PIC), having one or more biasing networks for providing biasing and termination and thereby enabling inductive peaking. In some examples, the EAM has an on-chip first biasing network including at least a termination inductor. A termination resistor can be provided either on-or off-chip, in series with the termination inductor, to provide biasing and termination when the EAM is driven by a differential driver. Configurations having a single such biasing network can provide single-ended termination and biasing. In some examples, a second biasing network can be added having another termination inductor. When arranged in series with an on-or off-chip termination resistor, the second biasing network can be used with the first biasing network to provide double-ended termination and biasing.

By providing both biasing and termination on-chip, examples described herein can avoid the need for a bias tee for biasing in addition to separate termination components. Furthermore, by providing an on-chip inductor along with an EAM integrated into the silicon of the PIC, inductive peaking can be enabled without the use of wire bonds to provide the induction necessary for inductive peaking configuration—the inductance of wire bonds tends to be poorly controlled, because the exact shape of the wire bond is not lithographically designed, and the geometry of the wire bonds and other components of the PIC tend to be limited by packaging constraints. Furthermore, in examples having two biasing networks—one connected to the anode of the EAM, and another connected to the cathode of the EAM—a differential drive configuration is enabled, thereby potentially capturing some of the benefits described above (e.g., reduced cross-talk, low non-linearity).

By providing integrated, on-PIC components for inductive peaking, devices and methods described herein may be suitable for highly scalable production of EAMs, including EAMs integrated into flip-chip PIC configurations. Existing approaches to inductive peaking for EAMs tend to rely on external components for inductive peaking, including separate components for termination and biasing. By reducing the reliance on external components and combining termination and biasing, examples described herein can achieve higher components density and/or higher modulation bandwidth. Other technical features may be readily apparent to one skilled in the art from the following figures, descriptions, and claims.

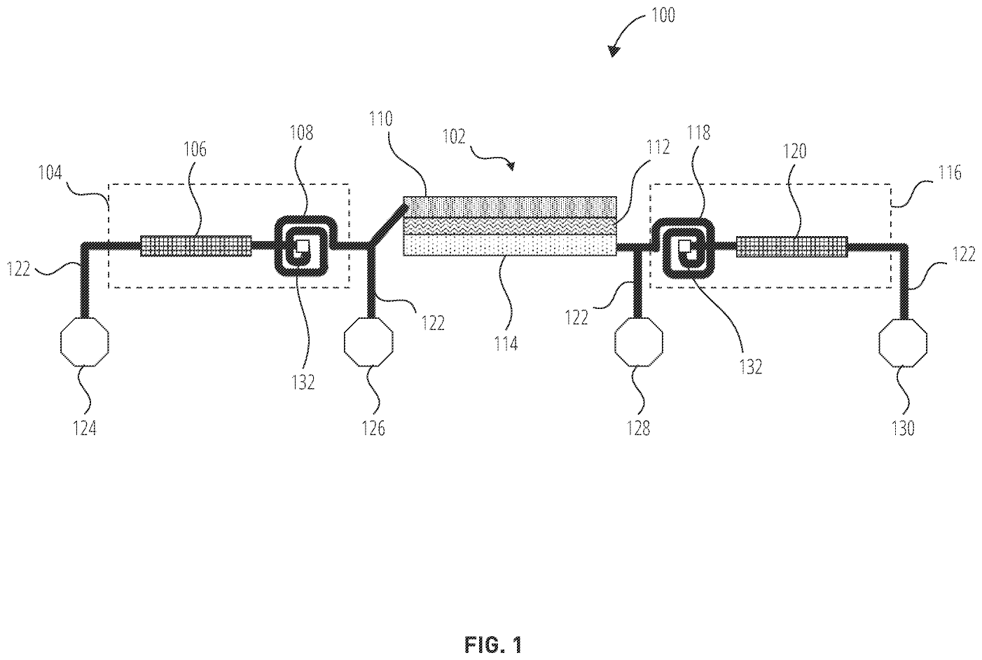

FIG. 1 illustrates a plan view of an example device 100, shown here as an electro-absorption modulator (EAM) 102 having two biasing networks, all formed on a PIC. A first biasing network 104 includes a first resistor 106 wired in series with a first inductor 108, for providing biasing and termination to a first end of the EAM. The first biasing network 104 is electrically coupled to a first electrode 110 of the EAM 102 (e.g., an anode formed from metal to form a p-type electrical contact). The EAM 102 includes a modulator junction 112 formed between the first electrode 110 and a second electrode 114 (e.g., a cathode formed from metal to form an n-type electrical contact). The second electrode 114 is electrically coupled to a second biasing network 116 having a second inductor 118 wired in series with a second resistor 120, for providing biasing and termination to the second end of the EAM.

In some examples, the EAM 102 is integrated into a PIC, such as a silicon photonic or indium phosphide PIC. The EAM 102 may include, within the modulator junction 112, an active region formed from a suitable semiconductor material (such as indium phosphide), and one or more photonic waveguides, such as silicon-based photonic waveguides. The termination resistors (shown as first resistor 106 and second resistor 120) and/or the termination inductors (shown as first inductor 108 and second inductor 118) can be formed from a metallization layer within the silicon or silicon-based substrate of the PIC. The metallization layer may also form the traces electrically coupling the components to each other, shown as metallization 122 in FIG. 1. Because the device 100 is not formed in association with a large conductive substrate, the degree of capacitance can be reduced or controlled. This allows current to be injected on both sides of the EAM 102.

The device 100 includes a first terminal 124 at a distal end of the first biasing network 104, positioned at an opposite end of the biasing network 104 from the EAM 102, a second terminal 126 between the first biasing network 104 and the EAM 102, a third terminal 128 between the EAM 102 and the second biasing network 116, and a fourth terminal 130 at a distal end of the second biasing network 116, positioned at an opposite end of the second biasing network 116 from the EAM 102. The terminals can be implemented as wire bond pads, as vias (e.g., copper pillars), or any other suitable on-chip electrical terminal. The terminals can be used to electrically couple different nodes of the device 100 to various other components on-of off-chip, such as grounds, current sources, and so on. Some example configurations are described below.

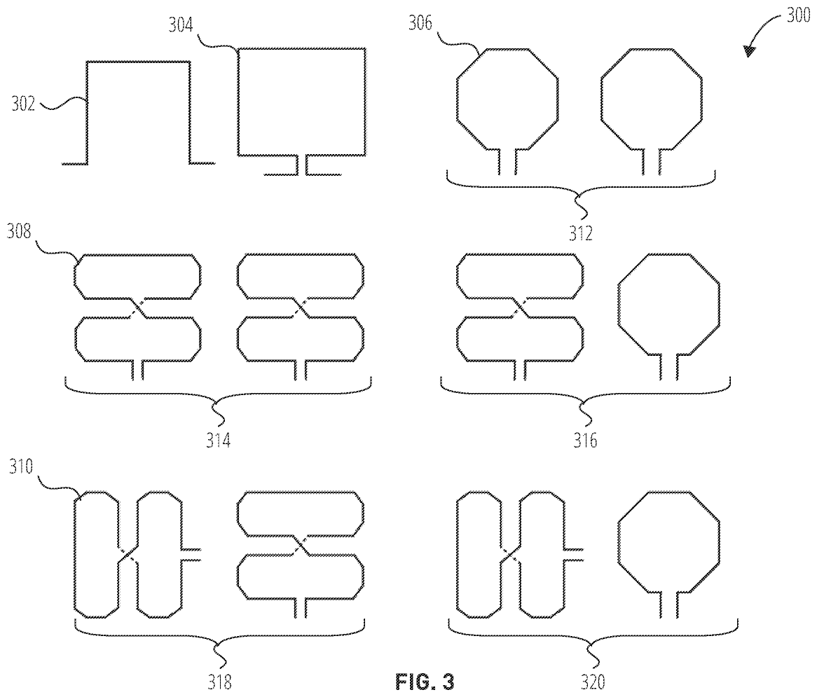

In some examples, the first inductor 108 and/or the second inductor 118 are formed lithographically on the PIC. The first inductor 108 and second inductor 118 are shown having a particular shape formed within the metallization layer in the plan view of FIG. 1. In some examples, the first inductor 108 and/or second inductor 118 can include a via 132 to connect two segments of the inductor and allows for the inductor to cross itself by interconnects segments of the inductor located in different metal layers. Alternative shapes for the first inductor 108 and second inductor 118 are described below with reference to FIG. 3. It will be appreciated that the arrangement of the components in the figures provide simplified topological examples of circuits, and various physical layouts of the components are possible. For example, the EAM 102 and the termination resistors do not need to be physically in-line or parallel.

It will be appreciated that, in some examples, the first resistor 106 and/or the second resistor 120 can be provided off-chip, e.g., as a discrete component on a printed circuit board (PCB) or metal-organic substrate. In some examples, one of the first biasing network 104 or the second biasing network 116 can be omitted, such that the device 100 provides only single-ended biasing and termination instead of double-ended. Some such examples are described below.

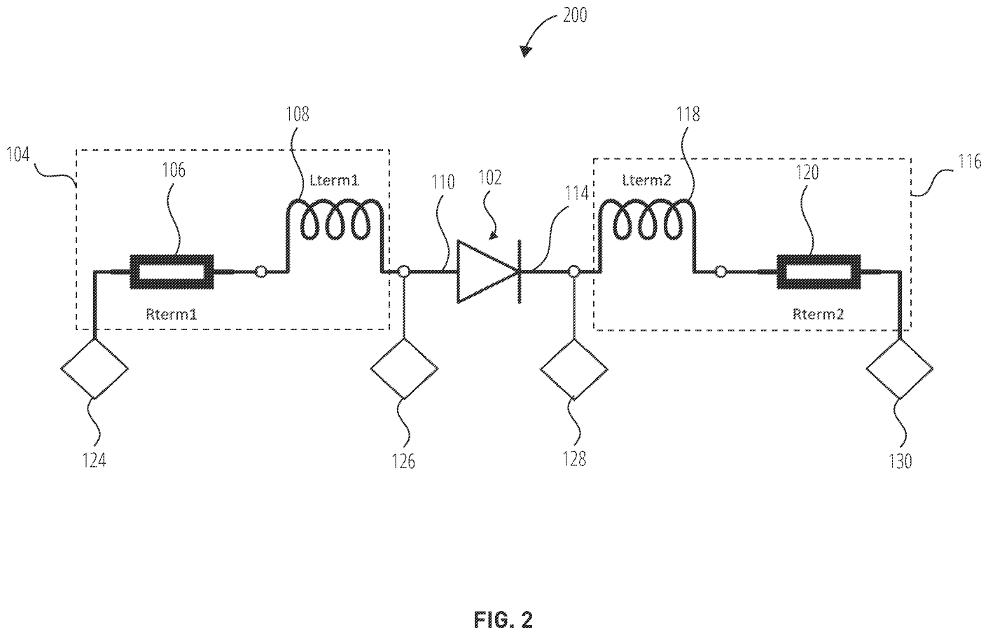

FIG. 2 illustrates a circuit diagram equivalent of the EAM 102 of FIG. 1, shown as device circuit 200. The components of the device 100 shown in FIG. 1 are shown in FIG. 2 as abstract circuit components. The first resistor 106 is shown having a termination resistance Rterm1, and the first inductor 108 is shown having a resistance induction of Lterm1. The second resistor 120 is shown having a termination resistance Rterm2, and the second inductor 118 is shown having a resistance induction of Lterm2.

FIG. 3 illustrates examples of alternative termination inductor shapes for the first inductor 108 and/or second inductor 118. Either inductor can use a first inductor shape 302, a second inductor shape 304, a third inductor shape 306, a fourth inductor shape 308, or a fifth inductor shape 310 to define the shape of the inductor within the metallization layer of the PIC. In some cases, the various alternative inductor shapes can be paired to define a first pair 312, a second pair 314, a third pair 316, a fourth pair 318, or a fifth pair 320 of such shapes for the first inductor 108 paired with the second inductor 118, in either order (e.g., first inductor 108 having the left-side shape of the pair and second inductor 118 having the right-side shape of the pair, or vice-versa).

Each shape includes two leads for connection to the traces on either end of the inductor. The fourth inductor shape 308 and fifth inductor shape 310 are shown as rotated counterparts of roughly a figure-8 shape, in which the metal crosses over itself by means such as vertical separation—in some examples, one or more vias may be used to interconnect segments of the inductor formed in different metallization layers in order to avoid electrical interconnection at the crossing-over point.

It will be appreciated that, in some examples, the inductors can be implemented as any suitable shape of metal or another suitable conductive material that results in inductance increased over a straight wire. The example inductors described herein is not intended to limit the range of geometries or materials usable to form inductors. In some cases, one or more of the inductors can be a combination of inductor and resistor that combines the function of one or more of the termination resistors and one or more of the termination inductors: for example, a poor resistor material can be selected, resulting in a resistor that needs to be relatively long to provide the necessary resistance, and this lengthened material can then be looped or otherwise convoluted to create an inductor.

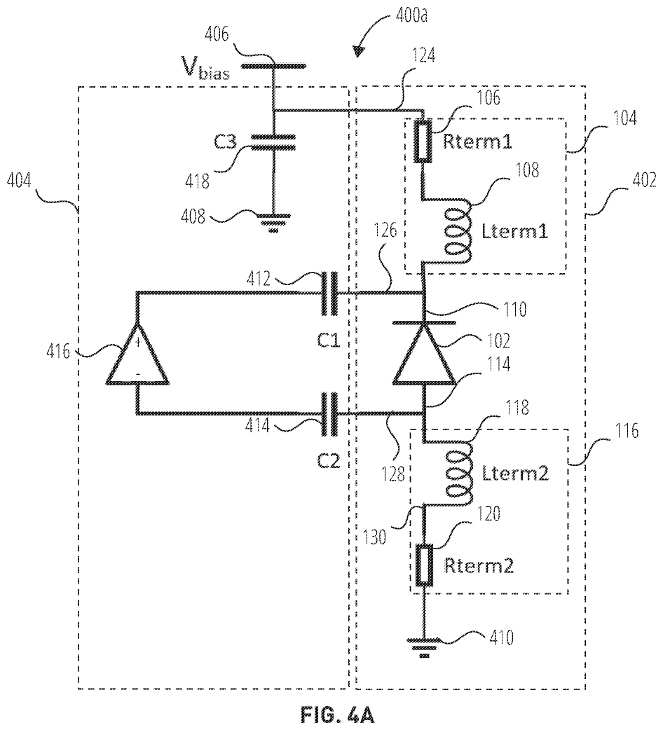

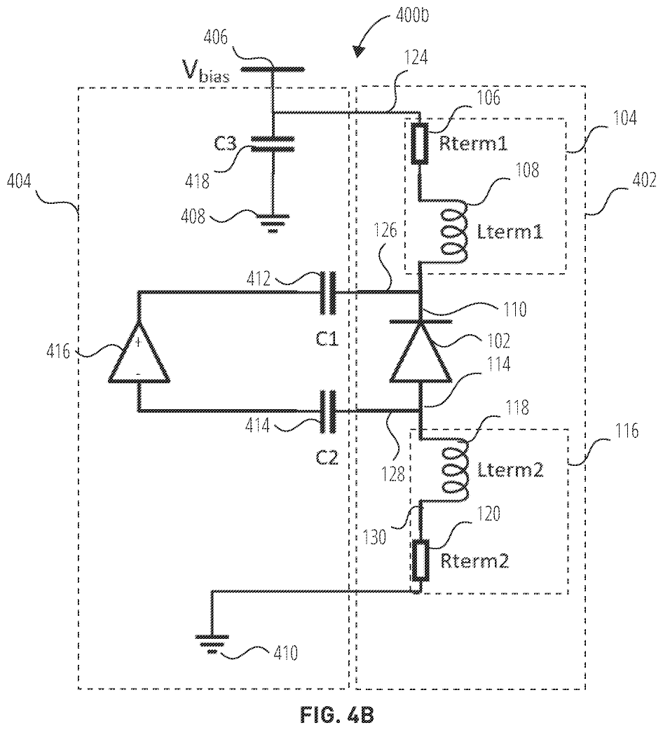

FIG. 4A illustrates a circuit diagram of a device, shown as device circuit 400a. The device circuit 400a includes components formed on a PIC 402, such as an on-chip EAM 102, as well as several external components 404 located off-chip.

The on-chip components of the device, formed on the PIC 402, include the components shown in the device 100 of FIG. 1 or the device circuit 200 of FIG. 2: in addition to the EAM 102, the on-chip components of the PIC 402 include the first resistor 106, first inductor 108, second inductor 118, and second resistor 120. An on-chip ground 410 is connected to the fourth terminal 130. However, in some examples (such as the circuit shown in FIG. 4B) the ground 410 may be located off-PIC.

The external components 404 include a bias voltage supply 406, shown having voltage V_{bias}, for reverse-biasing the modulator junction 112 (shown in FIG. 1) of the EAM 102. The bias voltage supply 406 is coupled to the first terminal 124, such that the first biasing network 104 is electrically coupled in series between the bias voltage supply 406 and the first electrode 110 of the EAM 102. In some examples, the bias voltage supply 406 is coupled to the first terminal 124 in parallel with a decoupling capacitor 418 connected to ground 408. The external components 404 also include a differential signal source 416 (such as a differential amplifier, a Serializer/Deserializer with an integrated driver, a retimer, or any other suitable differential signal source) providing a differential signal between the second terminal 126 and third terminal 128. The differential signal source 416 is electrically coupled to the second terminal 126 (and thus the first electrode 110) via a first capacitor 412, and the differential signal source 416 and is electrically coupled to the third terminal 128 (and thus the second electrode 114) via a second capacitor 414.

In operation, the EAM 102 as configured in the device circuit 400a may operate as a reverse biased p-i-n diode having a p-type semiconductor layer in contact with the first electrode 110, an n-type semiconductor layer in contact with the second electrode 114, and an intrinsic layer providing the modulator junction 112. The bias current from bias voltage supply 406 flows through first resistor 106, first inductor 108, EAM 102, second inductor 118, and second resistor 120 to ground 410. The DC bias current is prevented from flowing through the biasing networks of the driver (e.g., differential signal source 416) by two AC coupling capacitors, first capacitor 412 and second capacitor 414. The differential signal from the differential signal source 416 is coupled through first capacitor 412 and second capacitor 414.

The first capacitor 412 has a capacitance of C1. The second capacitor 414 has a capacitance of C2. In some examples, the first capacitor 412 and/or second capacitor 414 can be formed on the PIC 402 instead of being provided as external components 404. In some examples, the first capacitor 412 and/or second capacitor 414 can be implemented as on-chip capacitors on an integrated circuit of the driver (e.g., differential signal source 416). In some examples, the first capacitor 412 and/or second capacitor 414 can be discrete capacitors on a circuit board or a multi-chip module substrate.

FIG. 4B shows a variant device circuit 400b of the device circuit 400a of FIG. 4A, modified to have an off-PIC ground 410. The ground 410 may be located on or off the PIC 402 in various examples.

Thus, the device circuits 400a and 400b may each provide a differential biasing and termination scheme for an on-chip EAM 102.

In some examples, a single-ended biasing and termination scheme may be provided by omitting the first biasing network 104 from the device circuit 400a. The biasing scheme may be applied to only one side of the EAM 102 using the second biasing network 116, with the other side (e.g., first electrode 110) connected (via second terminal 126) to ground, connected to a DC voltage (e.g., bias voltage supply 406), or left floating.

In some examples, the configuration shown in FIG. 4A could be reversed, such that the bias voltage supply 406 could be connected to the second biasing network 116 with its polarity reversed, and the first biasing network 104 could be connected to a ground, such as ground 410.

Thus, examples described herein can encompass both differential and single ended operation, with either positive or negative supply. In a first example, a single-ended positive biasing and termination scheme is provided in which a positive bias voltage source is connected to the second terminal 126, a radio-frequency alternating-current source is coupled to the third terminal 128, and the fourth terminal 130 is connected to ground. The first terminal 124 can be left floating. In a second example, a single-ended negative biasing and termination scheme is provided in which a negative bias voltage source is connected to the fourth terminal 130, a radio-frequency alternating-current source is coupled to the third terminal 128, and the second terminal 126 is connected to ground, with the first terminal 124 left floating. In a third example, a differential biasing and termination scheme is provided in which a positive bias voltage source is connected to the first terminal 124, a positive terminal of a differential radio-frequency alternating-current source is coupled to the second terminal 126, a negative terminal of the differential radio-frequency alternating-current source is coupled to the third terminal 128, and the fourth terminal 130 is connected to a negative bias voltage source. This third example differs from the examples of FIG. 4A and FIG. 4B insofar as the fourth terminal 130 is connected to a negative bias voltage source instead of being connected to ground 410.

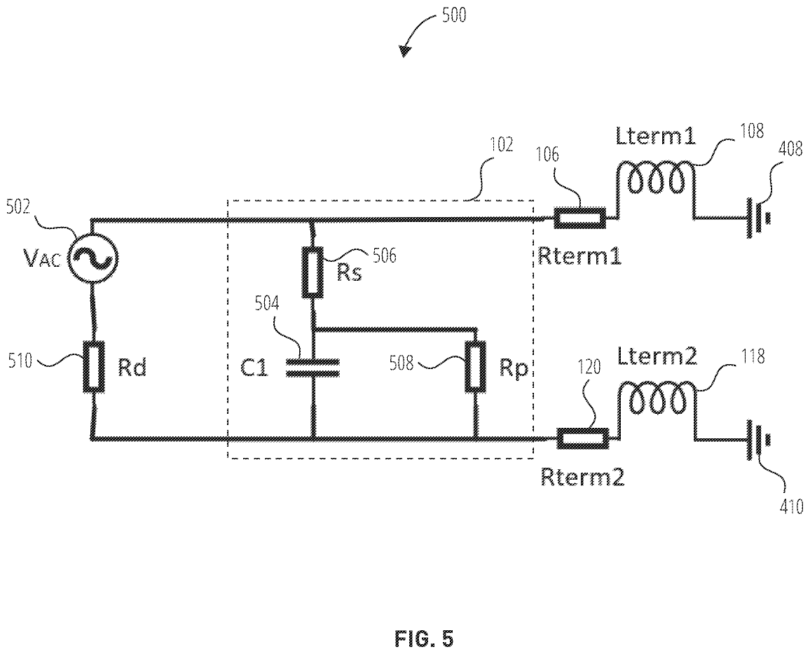

FIG. 5 illustrates a device circuit 500 including an on-chip EAM modeled as a sub-circuit. The device circuit 500 is similar to the device circuit 400a of FIG. 4A, but for the purpose of small signal analysis, the EAM 102 is modeled as a junction capacitor 504 having capacitance C1 (which may or may not be the same as the capacitance C1 of first capacitor 412 shown in FIG. 4A), a diode series resistor 506 having resistance Rs, and a diode photoresistor 508 having resistance Rp. The differential signal source 416 from FIG. 4A is replaced with a voltage source 502 and series termination resistor 510 having resistance Rd. The first resistor 106 and first inductor 108 are connected in series with ground 408 on a first side of the EAM 102; the second resistor 120 and second inductor 118 are connected in series with ground 410 on the second side of the EAM 102.

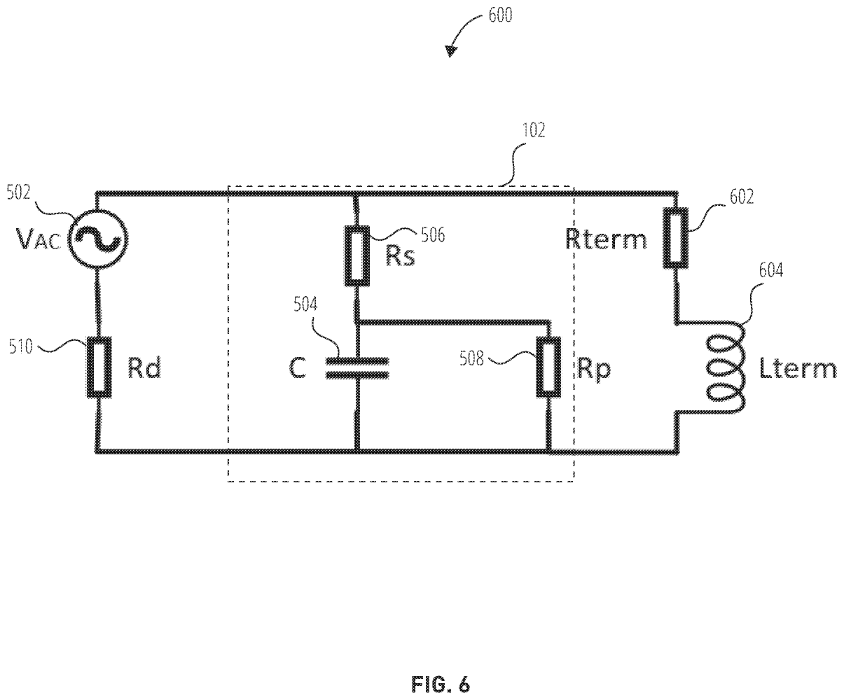

FIG. 6 illustrates a further simplified device circuit 600 that is mathematically equivalent to device circuit 500. In device circuit 600, first biasing network 104 and second biasing network 116 are modeled jointly as a combined termination resistor 602 and a combined termination inductor 604.

The ground 408 and ground 410 on the right hand side of FIG. 5 mean that the termination resistances of the first resistor 106 and second resistor 120, and the termination inductances of the first inductor 108 and second inductor 118, can be lumped together and represented as a combined termination resistor 602 having resistance Rterm and a combined termination inductor 604 having inductance Lterm, further simplifying the analysis.

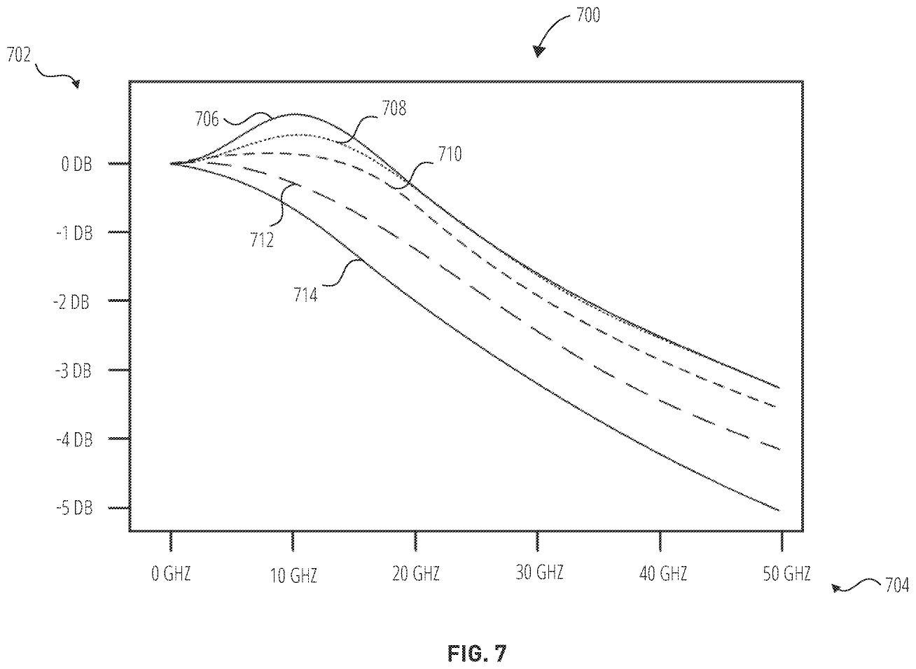

FIG. 7 illustrates a graph 700 of the frequency response of an on-chip EAM, such as EAM 102 of any of FIG. 1 through FIG. 6, with varying termination inductance. The vertical axis shows magnitude 702 of the response measured in decibels. The horizontal axis shows frequency 704 measured in gigahertz. The graph 700 shows traces of frequency response for 1600 pH 706 (1600 picohenries of inductance), 1200 pH 708, 800 pH 710, 400 pH 712, and 0 pH 714.

Given an inductance-dependent frequency response as shown in FIG. 7, the Laplace domain frequency response H(s) of the device circuit 600 of FIG. 6 (and consequently device circuit 400a or device circuit 500) can be modeled as:

$$H ( S ) = \frac{{sL}_{term} {R}_{p} + {R}_{term} {R}_{p}}{α + s ( C β + {L}_{term} γ ) + {s}^{2} {CL}_{term} δ}$$

$$wherein :$$

$$α = Rp * Rterm + Rs * Rterm + Rd * Rs + Rd * Rp + Rd * Rterm ,$$

$$β = Rs * Rp * Rterm + Rd * Rs * Rp + Rd * Rp * Rterm ,$$

$$γ = Rs + Rp + Rd ,$$

$$and$$

$$δ = Rs * Rp + Rd * Rp .$$

The addition of termination inductance by the first inductor 108 and second inductor 118 (e.g., modeled as combined termination inductor 604 having inductance Lterm) adds two complex conjugate poles in the H(s), thereby causing a reduction in high frequency insertion loss, improving return loss, and improving the modulation bandwidth of the EAM 102.

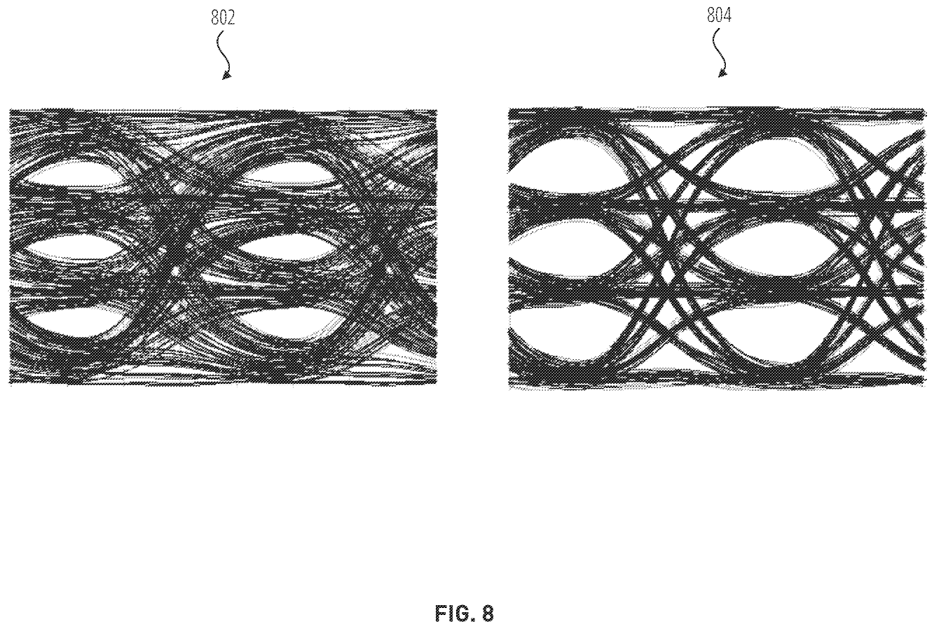

FIG. 8 illustrates time-domain eye diagrams of an EAM with and without termination inductance. The eye diagram 802 on the left shows the performance of an EAM without termination inductance. The eye diagram 804 on the right shows the significantly improved performance of an EAM, such as EAM 102, with termination inductance.

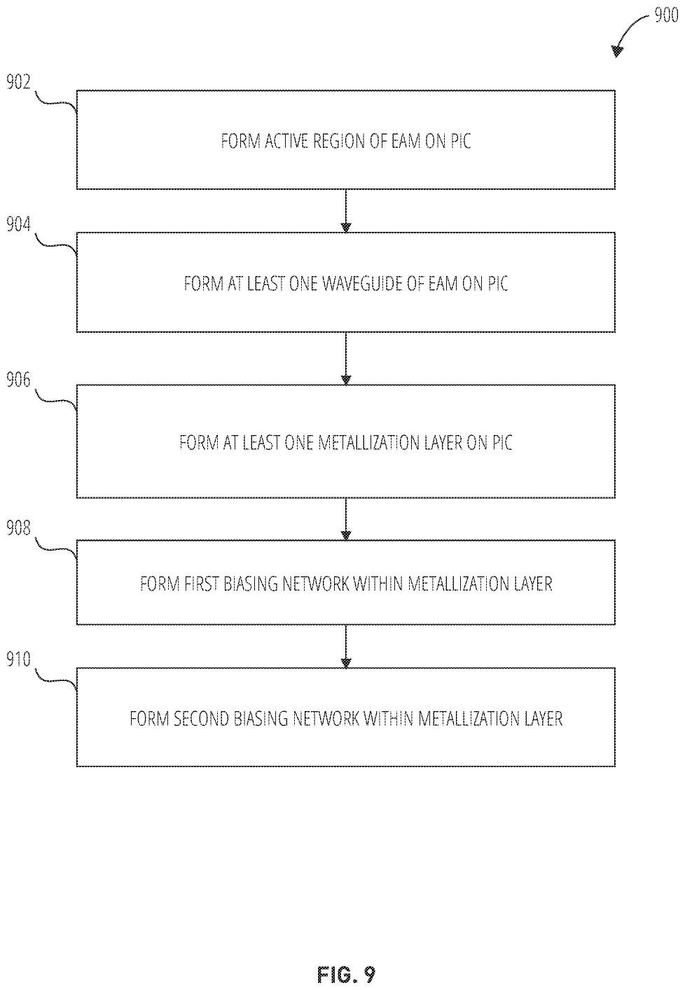

FIG. 9 illustrates a flowchart showing operations of a method 900 for manufacturing a photonic integrated circuit (PIC) having an EAM with on-chip termination inductance.

Although the example method 900 depicts a particular sequence of operations, the sequence may be altered without departing from the scope of the present disclosure. For example, some of the operations depicted may be performed in parallel or in a different sequence that does not materially affect the function of the method 900. In other examples, different components of an example device or system that implements the method 900 may perform functions at substantially the same time or in a specific sequence.

According to some examples, the method 900 includes forming an active region of the EAM on the PIC at operation 902. As described above, the active region may include an intrinsic layer of a p-i-n diode forming a modulator junction 112, and may be formed from indium phosphide or another suitable material.

According to some examples, the method 900 includes forming at least one waveguide of the EAM on the PIC at operation 904. As described above, the at least one waveguide may be formed as a silicon photonic waveguide.

According to some examples, the method 900 includes forming at least one metallization layer on the PIC at operation 906.

According to some examples, the method 900 includes forming a first biasing network 104 within the at least one metallization layer at operation 908. As described above, the first inductor 108 (and optionally first resistor 106) of the first biasing network 104 may be formed from metallization 122 along with the traces used to electrically interconnect them to each other and to the first electrode 110 of the EAM 102.

According to some examples, the method 900 includes forming second biasing network 116 within the at least one metallization layer at operation 910. As in operation 908, the second inductor 118 (and optionally second resistor 120) of the second biasing network 116 may be formed from metallization 122 along with the traces used to electrically interconnect them to each other and to the second electrode 114 of the EAM 102.

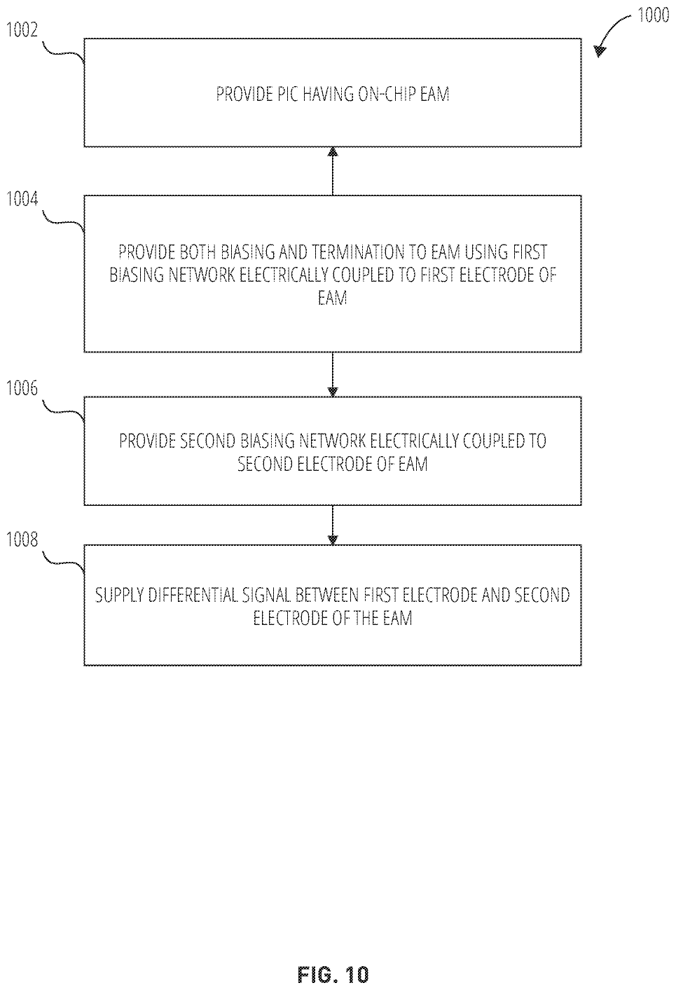

FIG. 10 illustrates a flowchart showing operations of a method 1000 for biasing and terminating an electro-absorption modulator (EAM) formed on a photonic integrated circuit (PIC).

Although the example method 1000 depicts a particular sequence of operations, the sequence may be altered without departing from the scope of the present disclosure. For example, some of the operations depicted may be performed in parallel or in a different sequence that does not materially affect the function of the method 1000. In other examples, different components of an example device or system that implements the method 1000 may perform functions at substantially the same time or in a specific sequence.

According to some examples, the method 1000 includes providing a PIC 402 having an on-chip integrated EAM 102 at operation 1002.

According to some examples, the method 1000 includes providing both biasing and termination to the EAM 102 using a first biasing network 104 electrically coupled to the first electrode 110 (e.g., one of the anode or cathode) of the EAM 102 at operation 1004.

According to some examples, the method 1000 includes providing a second biasing network 116 electrically coupled to the second electrode 114 (e.g., the other of the anode or cathode) of the EAM 102 at operation 1006.

According to some examples, the method 1000 includes supplying a differential signal between the first electrode 110 and the second electrode 114 of the EAM 102 at operation 1008. In some examples, the differential signal can be provided by a differential signal source 416 coupled to the EAM 102 via a pair of capacitors (e.g., first capacitor 412 and second capacitor 414), as shown in FIG. 4A.

Thus, examples described herein include devices and methods for providing an EAM having on-chip termination inductance for biasing and termination. Some examples may provide a combination of termination and biasing. Some examples may provide differential drive for an on-chip EAM. Some examples may provide termination and biasing on the PIC integrating the EAM.

Examples described herein may provide improved modulation bandwidth, improved signal integrity, reduced footprint on the PIC, increased interconnect density on the PIC, and/or simplified and/or faster system assembly.

In some examples, the techniques described herein can be applied to devices such as lumped-electrode Mach-Zehnder modulators.

In view of the disclosure above, various examples are set forth below. It should be noted that one or more features of an example, taken in isolation or combination, should be considered within the disclosure of this application.

The following are example embodiments:

Example 1 is a device comprising: a photonic integrated circuit (PIC) comprising: an electro-absorption modulator (EAM) formed on the PIC and having a first electrode and a second electrode, the first electrode and second electrode comprising an anode and a cathode; and a first biasing network electrically coupled to the first electrode for providing termination and biasing to the EAM, the first biasing network comprising: a first inductor formed on the PIC.

In Example 2, the subject matter of Example 1 includes, wherein: the EAM comprises: an active region; and at least one waveguide.

In Example 3, the subject matter of Example 2 includes, wherein: the active region comprises indium phosphide; and the at least one waveguide comprises silicon.

In Example 4, the subject matter of Examples 1-3 includes, wherein: the first inductor is formed lithographically on the PIC.

In Example 5, the subject matter of Examples 2-4 includes, wherein: the PIC comprises a silicon-based substrate; and the first inductor is formed in a metallization layer of the PIC.

In Example 6, the subject matter of Examples 1-5 includes, wherein: the first biasing network further comprises a first resistor electrically coupled in series with the first inductor.

In Example 7, the subject matter of Example 6 includes, wherein: the first resistor is formed on the PIC.

In Example 8, the subject matter of Examples 1-7 includes, a second biasing network electrically coupled to the second electrode for providing termination and biasing to the EAM, the second biasing network comprising: a second inductor formed on the PIC.

In Example 9, the subject matter of Example 8 includes, wherein: the second biasing network further comprises a second resistor electrically coupled in series with the second inductor.

In Example 10, the subject matter of Example 9 includes, wherein: the second resistor is formed on the PIC.

In Example 11, the subject matter of Examples 8-10 includes, a bias voltage supply, the first biasing network being electrically coupled in series between the bias voltage supply and the first electrode.

In Example 12, the subject matter of Example 11 includes, a ground, the second biasing network being electrically coupled in series between the ground and the second electrode.

In Example 13, the subject matter of Example 12 includes, a differential signal source coupled to the EAM to supply a differential signal between the first electrode and the second electrode.

In Example 14, the subject matter of Example 13 includes, a first capacitor electrically coupled between the differential signal source and the first electrode; and a second capacitor electrically coupled between the differential signal source and the second electrode.

In Example 15, the subject matter of Example 14 includes, wherein: the first capacitor and second capacitor are formed on the PIC.

In Example 16, the subject matter of Example 15 includes, wherein: the PIC comprises a silicon-based substrate; and the first inductor and second inductor are formed in a metallization layer of the PIC.

Example 17 is a method for biasing and terminating an electro-absorption modulator (EAM) formed on a photonic integrated circuit (PIC), the method comprising: providing a first biasing network electrically coupled to a first electrode of the EAM, the first biasing network comprising: a first inductor formed on the PIC.

In Example 18, the subject matter of Example 17 includes, wherein: the first biasing network further comprises a first resistor formed on the PIC and electrically coupled in series with the first inductor.

In Example 19, the subject matter of Example 18 includes, providing a second biasing network electrically coupled to a second electrode of the EAM for providing termination and biasing to the EAM, the second biasing network comprising: a second inductor formed on the PIC; and a second resistor formed on the PIC and electrically coupled in series with the second inductor.

Example 20 is a method for manufacturing a photonic integrated circuit (PIC),

comprising: forming an electro-absorption modulator (EAM) by forming, on the PIC: an active region of the EAM; and at least one waveguide of the EAM; forming at least one metallization layer on the PIC; and forming, within the at least one metallization layer: a first biasing network, the first biasing network being electrically coupled to a first electrode of the EAM and comprising: a first inductor; and a first resistor electrically coupled in series with the first inductor; and a second biasing network, the second biasing network being electrically coupled to a second electrode of the EAM and comprising: a second inductor; and a second resistor electrically coupled in series with the second inductor.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

What is claimed is:

1. A photonic integrated circuit (PIC) comprising:
an on-chip electro-absorption modulator (EAM) integrated into the PIC and having a first electrode and a second electrode, the first electrode and second electrode comprising an anode and a cathode; and
a first biasing network electrically coupled to the first electrode, the first biasing network providing both termination and biasing to the EAM, the first biasing network comprising:
a first inductor formed on the PIC.

2. The PIC of claim 1, wherein:
the EAM comprises:
an active region; and
at least one waveguide.

3. The PIC of claim 2, wherein:
the active region comprises indium phosphide; and
the at least one waveguide comprises silicon.

4. The PIC of claim 1, wherein:
the first inductor is formed lithographically on the PIC.

5. The PIC of claim 2, wherein:
the PIC comprises a silicon-based substrate; and
the first inductor is formed in a metallization layer of the PIC.

6. The PIC of claim 1, wherein:
the first biasing network further comprises a first resistor electrically coupled in series with the first inductor.

7. The PIC of claim 6, wherein:
the first resistor is formed on the PIC.

8. The PIC of claim 1, further comprising:
a second biasing network electrically coupled to the second electrode for providing termination and biasing to the EAM, the second biasing network comprising:
a second inductor formed on the PIC.

9. The PIC of claim 8, wherein:
the second biasing network further comprises a second resistor electrically coupled in series with the second inductor.

10. The PIC of claim 9, wherein:
the second resistor is formed on the PIC.

11. The PIC of claim 8, wherein the PIC forms part of a device comprising:
a bias voltage supply,
the first biasing network being electrically coupled in series between the bias voltage supply and the first electrode.

12. The PIC of claim 11, wherein the device further comprises:
a ground,
the second biasing network being electrically coupled in series between the ground and the second electrode.

13. The PIC of claim 12, wherein the device further comprises:
a differential signal source coupled to the EAM to supply a differential signal between the first electrode and the second electrode.

14. The PIC of claim 13, wherein the device further comprises:
a first capacitor electrically coupled between the differential signal source and the first electrode; and
a second capacitor electrically coupled between the differential signal source and the second electrode.

15. The PIC of claim 14, wherein:
the first capacitor and second capacitor are formed on the PIC.

16. The PIC of claim 15, wherein:
the PIC comprises a silicon-based substrate; and
the first inductor and second inductor are formed in a metallization layer of the PIC.

17. A method comprising:
providing a photonic integrated circuit (PIC) comprising an on-chip electro-absorption modulator (EAM) integrated into the PIC;
providing both biasing and termination to the EAM using a first biasing network electrically coupled to a first electrode of the EAM, the first biasing network comprising:
a first inductor formed on the PIC; and
supplying a differential signal between the first electrode and a second electrode of the EAM.

18. The method of claim 17, wherein:
the first biasing network further comprises a first resistor formed on the PIC and electrically coupled in series with the first inductor.

19. The method of claim 18, wherein the biasing and termination are further provided to the EAM by: a second biasing network electrically coupled to a second electrode of the EAM, the second biasing network comprising:
a second inductor formed on the PIC; and
a second resistor formed on the PIC and electrically coupled in series with the second inductor.

20. A method for manufacturing a photonic integrated circuit (PIC), comprising:
forming an electro-absorption modulator (EAM) by forming, on the PIC:
an active region of the EAM; and
at least one waveguide of the EAM;
forming at least one metallization layer on the PIC; and
forming, within the at least one metallization layer:
a first biasing network providing both biasing and termination to the EAM, the first biasing network being electrically coupled to a first electrode of the EAM and comprising:
a first inductor; and
a first resistor electrically coupled in series with the first inductor; and
a second biasing network, the second biasing network being electrically coupled to a second electrode of the EAM and comprising:
a second inductor; and
a second resistor electrically coupled in series with the second inductor.
